(19) United States
(12) Patent Application Publication
(10) Pub. No.: US 2021/0031299 A1
(43) Pub. Date: Feb. 4, 2021

(54) LASER BEAM POSITIONING SYSTEM, LASER PROCESSING DEVICE AND CONTROL METHOD

(71) Applicant: SCANLAB GmbH, Puchheim (DE)

(72) Inventor: Gerald Schmid, Puchheim (DE)

(21) Appl. No.: 17/046,157

(22) PCT Filed: Apr. 3, 2019
(86) PCT No.: PCT/EP2019/058338

§ 371 Date: Oct. 8, 2020

(30) Foreign Application Priority Data
Apr. 9, 2018 (DE) 10 2018 205 270.0

(51) Int. Cl. B23K 26/04; B23K 26/082; B23K 26/0622; G05B 19/402; G02B 26/10

(52) U.S. Cl. CPC B23K 26/043; B23K 26/082; G05B 2219/40623; G05B 19/402; G02B 26/101; B23K 26/0622

(57) ABSTRACT

A method is provided of controlling a laser processing device with at least one laser. The method includes setting an optical path of the laser processing device by at least one rotatable mirror; a first triggering of the laser at a first point in time so as to generate a first laser spot; continuously adjusting, the optical path of the laser processing device; and a second triggering of the laser at a second point in time so as to generate a second laser spot. The method also includes, before the second triggering: determining the second point in time so that the position of the second laser spot has a desired distance, along the path, to the position of the first laser spot.

### CROSS-REFERENCE TO RELATED APPLICATIONS

This application is a national phase entry of, and claims priority to, International Application No. PCT/EP2019/058338, filed Apr. 3, 2019, which claims priority to German Patent Application No. 10 2018 205 270.0, filed Apr. 9, 2018, both with the same title as listed above. The above-mentioned patent applications are incorporated herein by reference in their entireties.

### TECHNICAL FIELD

This application relates to a laser beam positioning system, a laser processing device and a control method, specifically using a high clock frequency for such a control method.

### BACKGROUND

U.S. Pat. No. 8,426,768 discloses a system for controlling a laser beam along a desired path on a workpiece. The laser can be triggered at desired points in time so that laser spots are generated with a desired spacing along the path. In this context, the optical path of the laser is deflected by rotatable mirrors so that the laser spots come to lie on the desired path. In the course of this, the actual position of the axes of the rotatable mirrors is determined by measurement, from which the position of the optical path of the laser along the path can be calculated. The position of the optical path along the path determined in this way, or the current distance to a laser spot generated previously is subsequently compared with a desired distance. If the distance which has been determined on the basis of the actual positions is greater than, or equal to, the desired distance, the pulsed laser is triggered in order to generate a laser spot on a workpiece.

The inventors of the present invention have appreciated that the method described above is insufficient, at least for some applications. For example, in the processing industry there is a desire to increase the clock frequency of the pulsed laser, i.e., to shorten the temporal pulse intervals, to shorten the total processing time of a workpiece.

The inventors of the present invention have appreciated that the method described above requires relatively complex, in particular time-consuming, calculations in order to determine the distance between a laser spot generated previously and the current position of the optical path. This is because, for this purpose, it is necessary to determine the current positions of the axes of the mirrors, which represent X and Y coordinates, and then to calculate from this the X and Y coordinates of the optical path along the path on the workpiece. From this, the offset in the X and Y direction is then calculated. Thereafter, the squares of these offsets are formed and added together. The sum of the squares is finally compared to the square of the desired distance. These calculations and the subsequent comparison are performed until the sum of the squares of the current offsets in the X and Y direction have reached or exceeded the square of the desired distance. The laser is then triggered in order to generate a new laser spot on the workpiece.

Although a modern processor can carry out the calculations and the subsequent comparison described above in a relatively short period of time, the inventors of the present invention have appreciated that the method described still reaches its limits when the pulse interval is reduced, for example below 10 μs and possibly significantly below 10 μs.

It should also be noted that in many applications the laser cannot simply be triggered with a constant clock frequency. For example, in many applications it will be desirable to generate laser spots with a constant distance along the path. However, a laser which is triggered with a constant clock frequency would generally not (or not necessarily) generate equidistant laser spots, as will be explained in detail later. For this reason, in many applications it is necessary to individually determine (calculate) the points in time at which the laser is to be triggered.

Against this background, it would therefore be desirable to provide an improved method for controlling a laser processing device. In particular, provision should be made that it will also be possible to make use of the method according embodiments of to the invention at a higher clock frequency than is possible according to the state of the art.

### SUMMARY

To address these and other problems with the conventional systems and designs, a method is provided of controlling a laser processing device having at least one laser in one embodiment. The method includes setting an optical path of the laser processing device by at least one deflection element, in particular at least one rotatable mirror, so that a path point which can be generated by a laser beam following the optical path lies on a desired path on or in an object; a first triggering of the laser at a first point in time so as to generate a first laser spot; adjusting, in particular continuously adjusting, the optical path of the laser processing device by the at least one deflection element, in particular the at least one rotatable mirror, so that a path point which can be generated by the laser beam following the optical path lies on the desired path; and a second triggering of the laser at a second point in time so as to generate a second laser spot. The method also includes the following step before the second triggering: determining the second point in time on the basis of a target position and/or a first or a higher time derivative thereof and/or a first or a higher time derivative of the actual position of the path point of the optical path along the path, so that the position of the second laser spot has a desired distance, along the path, to the position of the first laser spot.

In contrast to the method known from the state of the art described above, a target position and/or a first or a higher time derivative thereof (target velocity, target acceleration etc.) and/or a first or a higher time derivative of the actual position (actual velocity, actual acceleration etc.) of the path point of the optical path along the path is used for determining the second trigger point in time. In particular, the target position and/or a time derivative thereof can be known in advance or can be determined in advance, so that the second trigger point in time can be determined in advance as well; i.e., the determining of the second trigger point in time can be started/carried out before the path point of the optical path of the device has reached a position at which a laser spot is to be generated. As a result of this, the generating of the second laser spot can become more precise (and thus the processing quality of a workpiece can be increased) than is possible according to the method known from the state of the art described above, and/or the clock frequency of the laser can be increased. Since the calculation in the method according to the state of the art is based on measured values of the actual position, at high spot velocities or short pulse intervals the laser spot has already moved further during the processing of these actual values, so that, at the time the laser is triggered, the actual path point of the optical path is no longer at the desired position. According to embodiments of the present invention, this problem can be reduced or eliminated.

The determining of the second point in time in accordance with embodiments of the invention can even be carried out before the initial setting of the optical path.

Nevertheless, in accordance with this embodiment of the invention, it is also provided that actual values can be used in the determining of the second trigger point in time. However, the actual position of the path point of the optical path is not used here, as is the case in the state of the art, but instead a first or a higher time derivative of the actual position of the path point of the optical path along the path. In particular, when using the first time derivative of the actual position, i.e. the actual velocity, the computational complexity can be reduced significantly when compared with the method known from the state of the art, so that also here the determining of the second trigger point in time can take place in a timely manner. This results in similar advantages regarding an increased clock frequency and/or a more precise positioning of the laser spots as in the case of using the target position or a time derivative thereof.

The use of a first or a higher time derivative of the target position, in particular the use of the target velocity, combines the advantages of using target values (the calculation can be done in advance) and velocity values (the calculations which are required for determining the second (trigger) point in time are simplified).

In a preferred embodiment, the second point in time is a point in time at which the path point of the optical path has reached or exceeded a desired minimum distance along the path from the position of the first laser spot.

In this manner, a minimum distance can advantageously be specified which the laser spots should maintain.

In another preferred embodiment, the method comprises at least a third triggering of the laser, and it is ensured that, per length of the path, the energy which is transmitted onto the object by the laser beam substantially corresponds to a desired distribution.

Accordingly, a desired distribution of the energy to be emitted per length of the path can advantageously be taken into account when the laser is triggered, which is of significance in many manufacturing processes.

In yet another preferred embodiment, the desired distribution specifies that the energy per length of the path is substantially constant.

In this manner, a uniform processing can be achieved, for example.

However, the desired distribution can also specify that the energy per length of the path is lower in curves of the path than on substantially straight sections of the path.

Such an energy distribution may be desired for various applications, for example to take into account that if the distance between the laser spots was constant and the energy per laser spot was constant, the energy applied to a workpiece by the laser spots would, in curves, be concentrated on a smaller area of the workpiece than would be the case in comparatively straight sections of the path. The energy per length of the path can be adjusted accordingly.

In a further preferred embodiment, the distance between successive laser spots is varied so that the energy per length of the path substantially corresponds to the desired distribution.

For example, by increasing the distance, it is possible to reduce the energy per length of the path.

Alternatively or additionally, it is possible to vary, for different laser spots, the energy which is transmitted onto the object by the laser beam in order to generate a laser spot, so that the energy per length of the path substantially corresponds to the desired distribution.

For example, the energy per length of the path is reduced by a lower energy per laser spot.

In one preferred embodiment, the laser spots have a size, and the desired distribution specifies that successive laser spots overlap only up to a maximum specified extent, and preferably that substantially they do not overlap.

This in turn can be of particular advantage in curves. Let us assume that the laser spots have a constant diameter D and the centers of the laser spots have a distance which also corresponds to D. In this case, on straight sections of the path, the laser spots are as close as possible to each other without overlapping. If this should also apply to curved sections, i.e. the laser spots should be as close as possible to each other without overlapping, the distance between the centers of the laser spots along the path would have to be increased in curved sections. Otherwise, peripheral areas of the laser spots would overlap due to the curvature of the path. According to embodiments of the invention, this can be taken into account when it comes to choosing the spacing of the laser spots.

In another preferred embodiment, the second point in time is determined on the basis of the first or the higher time derivative of the target position or of the actual position as follows: Repeating of the following steps: a) integrating the first or the higher time derivative of the target position or the actual position over a time interval in order to determine a first distance along the path; and b) comparing the first distance with the desired minimum distance along the path, until the first distance corresponds to, or exceeds, the desired minimum distance along the path; and determining the second point in time substantially from the sum of the time intervals.

According to this embodiment, the determining of the second point in time can be simplified compared to the method known from the state of the art described above. While, according to the state of the art, the adding of the squares of the X and Y coordinates is necessary, a first or a higher time derivative can be integrated, according to such embodiments of the invention, which in general requires less computational effort than in the state of the art.

In this embodiment, the steps of integrating and comparing are repeated until the calculated distance along the path corresponds to the desired minimum distance. This minimum distance is, so to speak, the distance which the laser spots have in an ideal scenario. However, depending on the size of the selected time interval which is used for the integration, it is more likely that the first distance which results from the iterative integrating and comparing will be slightly larger than the desired minimum distance. Accordingly, the distance between the first and the second laser spot will be (slightly) larger than the desired minimum distance. However, by a suitably short time interval which is used for the integration, this deviation can be kept very small so that the slightly increased distance will not have a negative effect on the overall result.

Nevertheless, the deviation which has arisen during the course of the determination of a trigger point in time can be taken into account during the course of the determination of the subsequent trigger point in time. This means that, during the course of the determination of the next trigger point in time, the integration does not start again from zero, but from a value that corresponds to the deviation arising from the determination of the preceding trigger point in time. In this way it is possible to ensure that the average deviation, i.e. the amount by which the distances which have been determined exceed the desired minimum distance, is kept small.

As an alternative to this, further points in time which are subsequent to the second point in time can be determined according to the determination of the second point in time, without taking into account to what extent the desired minimum distance was exceeded during the course of the determination of the preceding point in time.

As a result of this, the computing complexity can be kept particularly low. This variant can be chosen if highest precision, i.e. an adjustment as precise as possible of the actual distances between the laser spots to the desired minimum distance, is not necessary and the minimization of the computational complexity has priority.

In a further preferred embodiment, the second point in time is determined on the basis of the target position as follows: for a given point in time, determining whether the target position which is associated with the given point in time corresponds to a distance along the path that is equal to the desired minimum distance or has exceeded the desired minimum distance along the path; if yes, using the given point in time as the second point in time; if no, adding a time interval to the given point in time; and repeating the preceding steps.

Although position values are used to determine the second trigger point in time according to this embodiment, this embodiment nevertheless has advantages over the state of the art described above because the method is based on target values and not on measured actual values. Accordingly, the second trigger point in time can be determined in advance, i.e. (significantly) before a point in time at which the axes of the rotatable mirrors assume positions corresponding to these target positions. In the state of the art, the second trigger point in time is only determined when the axes of the rotatable mirrors have already assumed such positions.

In other embodiments, a computer program product is provided and includes a program code which is stored on a computer-readable medium for carrying out any one of the methods described above.

This can be used, for example, when retrofitting a laser beam positioning system which is already in existence.

In further embodiments, a laser beam positioning system is provided which is arranged to carry out any one of the methods described above.

In this context it needs to be considered that the actual laser can form part of the laser beam positioning system, but that embodiments of the invention also extends to laser beam positioning systems which do not have a laser themselves. Such a laser beam positioning system can be manufactured as a substantially independent system, i.e., without laser. The laser to be controlled can be provided separately. However, such a laser beam positioning system would have suitable means for triggering, at appropriate times, a laser to be used with the laser beam positioning system.

In still further embodiments, a laser beam positioning system is provided for controlling a laser processing device. The laser beam positioning system includes: at least one deflection element, in particular at least one rotatable mirror, means for setting or adjusting, in particular for continuously adjusting, the at least one deflection element, in particular the at least one rotatable mirror, to set or adjust an optical path of the laser beam positioning system in such a way that a path point which can be generated by a laser beam following the optical path lies on a desired path on or in an object; means for triggering, at first and second points in time, a laser to be used with the laser beam positioning system in order to generate a first and a second laser spot; and means for determining the second point in time on the basis of a target position and/or a first or a higher time derivative thereof and/or a first or a higher time derivative of the actual position of the path point of the optical path along the path, so that the position of the second laser spot has a desired distance, along the path, to the position of the first laser spot.

In another embodiment, a laser processing device is provided and includes a laser and any one of the laser beam positioning systems described above.

The features and advantages explained with respect to preferred embodiments of one of the embodiments of the invention also apply in a corresponding manner to other embodiments of the invention, e.g., the features described can be combined across different embodiments without departing from the scope of this disclosure.

### BRIEF DESCRIPTION OF THE DRAWINGS

The accompanying drawings, which are incorporated in and constitute a part of this specification, illustrate one or more embodiments of the invention and, together with the general description given above and the detailed description given below, explain the one or more embodiments of the invention.

FIG. 1 is a perspective view of a laser processing device according to one embodiment of the present invention.

FIG. 2 is a schematic, simplified representation or variant of the laser processing device of FIG. 1.

FIG. 3 is a graphical plot of the calculation of a trigger point in time according to one embodiment of the present invention.

FIG. 4 is a graphical plot of a speed profile according to an embodiment of the present invention.

FIG. 5 is a graphical plot of a course of positions according to an embodiment of the present invention.

FIG. 6 is a schematic diagram of a path with laser spots according to one embodiment of the present invention.

FIG. 7 is a schematic diagram of a path with laser spots according to another embodiment of the present invention.

FIG. 8 is a flow chart illustrating a method according to a further embodiment of the present invention.

### DETAILED DESCRIPTION

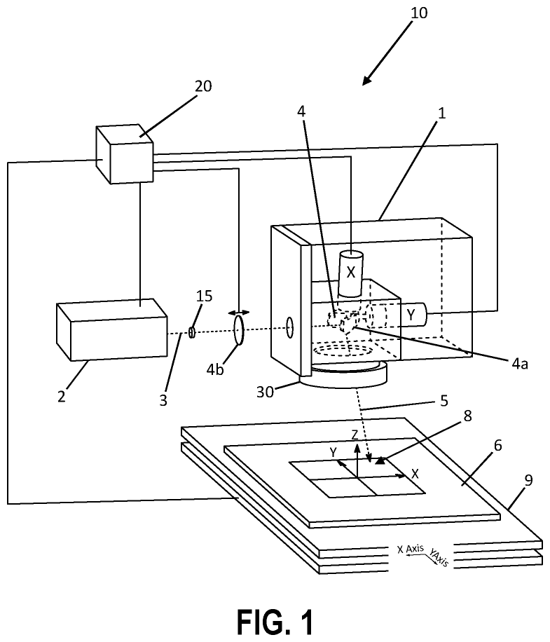

The laser processing device 10 shown in FIG. 1 comprises a pulsed laser 2. When triggered, this can generate a laser beam 3. Depending on the implementation, the laser beam can optionally, as shown in the example embodiment, be passed through a beam expander 15, which expands the laser beam 3. In the example embodiment shown, the laser beam is then passed through a focusing device 4b, which can focus the laser beam 3. This focusing device is also optional. In FIG. 1, the focusing device 4b is represented by a lens, but it can also comprise several lenses, for example. Where applicable, a lens of the focusing device 4b can be moved along the axis of the laser beam as indicated by the double arrow. This allows the position of the focal point of the laser beam to be selected or changed.

The laser beam 3 then hits a rotatable mirror 4a, which deflects the laser beam 3. After having been deflected by the rotatable mirror 4a, the laser beam 3 hits another rotatable deflection mirror 4, which deflects it in the direction of an object 6.

The rotatable mirrors 4, 4a are part of a laser beam positioning system 1, which can also include, among other things, an objective 30, as is in principle known from the state of the art. In the example shown, the deflection mirrors 4, 4a are arranged in such a way that they can rotate around axes that include a 90° angle. Other angles would also be conceivable, but choosing a 90° angle can make it easier to calculate the position of the focal point from the axis positions of the mirrors. The rotatable deflection mirrors 4, 4a can be rotated by galvanometer drives, for example.

The laser beam deflected by the mirrors 4, 4a then hits an object 6. In FIG. 1, the portion of the laser beam 3 which has been deflected by the mirrors 4, 4a carries the reference sign 5.

In FIG. 1, a focal point 8 is indicated for the deflected part 5 of the laser beam. The laser beam 5 is focused on this point by the focusing device 4b. As shown in FIG. 1, this focal point can be located on the surface of the object 6 as shown, i.e. on the object 6. However, it is also possible that the laser beam 5 can be focused by the focusing device 4b in such a way that the focal point is located in the object 6. The latter can for example be used in connection with an object 6 that is at least partially transparent to the electromagnetic radiation that the laser 2 can generate.

When the laser 2 is triggered, the laser 2 or the laser beam 3, 5 generates a laser spot at the position of the focal point 8. If the laser 2 is triggered several times in succession, a series of laser spots is generated in or on the object 6. For the sake of simplicity, in the following, the reference sign 8 is also used for the laser spot(s).

An optical path for the laser 2 is defined by the deflection mirrors 4, 4a and, if present, the focusing device 4b. In the following, the reference sign 40 is used for the optical path, although this is not shown in the drawings. The optical path 40 corresponds to a line along which the laser beam 3, 5, starting at the laser 2, would propagate if the laser 2 was triggered. The optical path is therefore also defined at such times when the laser 2 is not triggered. Likewise, the optical path 40 can be considered as being defined if the laser 2 is not present because the optical path is defined by the deflection mirrors 4, 4a and, if present, the focusing device 4b.

If the mirrors 4, 4a and, if applicable, the focusing device 4b are adjusted, the optical path 40 changes and thus also the position of the focal point 8. The optical path 40 or the focal point 8 thus describes a path that lies at least partially, in particular completely, in or on the object 6. Individual path points are located along this path, which are described below and for which the reference sign 8 is also used.

In the example embodiment shown, the laser beam positioning system 1 comprises a control system 20. By this control system, in particular the deflection mirrors 4 or 4a and the focusing device 4b can be controlled and/or their (axis) positions can be determined. As shown in FIG. 1, it is possible to connect the control system 20 to the laser 2, in particular it can be connected to the laser 2. In this way, the laser 2 can be triggered at suitable points in time.

The invention is not limited to the implementation shown in FIG. 1. In particular, the entire control system 20 for the mirrors 4, 4a, the focusing device 4b and the laser 2 may be integrated into the housing in which the mirrors 4, 4a are located, or the control system 20 for the mirrors 4, 4a, the focusing device 4b and the laser 2 may, as shown in FIG. 1, be positioned at least partially outside such a housing.

Regardless of the particular implementation, the mirrors 4, 4a and the control system 20, if applicable together with other optical elements, can be regarded as a laser beam positioning system. It is noted again that the laser 2 is not, or at least not necessarily, a part of this system. The laser beam positioning system 1 can be provided separately, for use with a laser 2. The combination of the laser beam positioning system 1 and the laser 2 can be regarded as a laser processing device 10.

According to a variant of the arrangement shown in FIG. 1, it would be possible for the laser beam positioning system to comprise only one of the deflection mirrors 4, 4a, which in such an embodiment can only be rotated around one axis. In this case the optical path would have one degree of freedom less.

As shown in FIG. 1, the object 6 can optionally be positioned on a stage 9, in particular on a movable stage 9, by which the object 6 can, for example, be moved in one or more of the directions indicated in FIG. 1 by the arrows X, Y (and possibly also Z). Suitable movable stages or similar are known to the person skilled in the art.

As a further variant, it is possible to use other deflection elements instead of deflection mirrors 4, 4a. In particular, optical waveguide or prisms could be considered for this purpose. It would also be possible to combine different types of deflection elements with each other, for example a mirror and an optical waveguide. However, at least one of the deflection elements must in this embodiment be such that it can be adjusted/modified with respect to its position, orientation or shape (in particular in the case of an optical fiber), so that the optical path of the laser processing device can be adjusted accordingly.

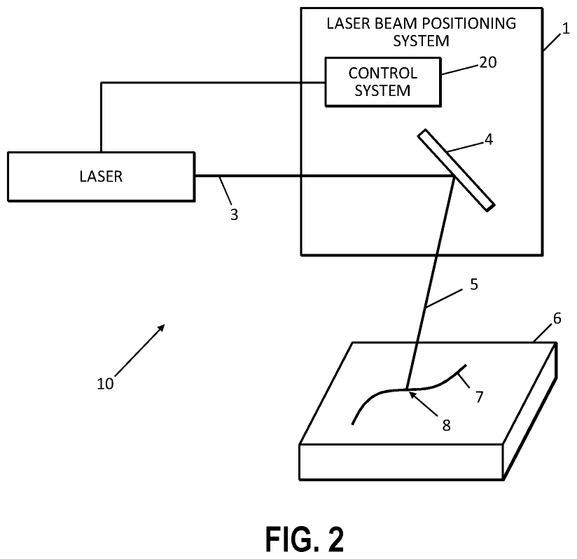

FIG. 2 can be regarded as a variant of FIG. 1 or as a simplified representation of FIG. 1. FIG. 2 again shows a pulsed laser 2, from which a laser beam can emanate that can be deflected by a deflection element 4, for example a mirror, in the direction of an object 6. The mirror is part of the laser beam positioning system 1, which also comprises a control system 20. This can trigger the laser via a suitable control line 21.

Here, the deflection mirror 4 is representative for one or more deflection elements.

The laser beam which is deflected by the deflection mirror 4 again carries the reference sign 5. Where the laser beam 5 hits the object 6, a laser spot 8 (at focal point 8) is generated. The optical path of the laser processing device 10 is adjusted by suitable control of the deflection mirror 4 in such a way that it describes a path 7 on the object 6.

A continuous path 7 is generated through continuous adjustment of the at least one deflection mirror 4, as shown in FIG. 2. However, since the laser 2 is triggered at certain separate points in time, the laser spots which are generated in this way form a series of points spaced from one another, which in reality will, however, have a certain extent. Due to this extent it is possible—depending on the implementation—that the laser spots will overlap.

It will now be described how the points in time at which the laser 2 is triggered are determined. In this context the centers of the laser spots are preferably meant, when reference is made to the position of the laser spots or the distance between two adjacent laser spots.

Three example embodiments of the present invention will now be described. In all of these it is assumed that the deflection elements 4 are set or adjusted in such a way that a path point 8 which can be generated by a laser beam 3, 5 following the optical path 40 lies on a desired path 7 on or in the object 6.

### Example Embodiment 1: Target Speed

The deflection mirrors 4 are controlled in such a way that the optical path describes the desired path 7. In particular, if position controllers without tracking errors are used for the deflection mirrors 4, the controlling of the deflection mirrors 4 can be used to determine the position which the optical path will assume on the desired path 7 at different points in time. This is therefore not a (measured) actual position of either the deflection mirrors 4 or of the optical path 40 along the desired path. Rather, the target position of the optical path on the desired path can be determined from the controlling, in particular even before the position controllers of the deflection mirrors 4 are activated. In a manner known in principle, the target speed Vₛₒₗₗ along the path can also be determined from this. This target speed can be represented by a scalar because the direction of movement is given anyway by the specification of the desired path.

The method according to this example embodiment envisages that the target speed is integrated in small time intervals. The integration steps can be 10 ns, for example. In any case it is desirable that the integration time interval is much shorter than the expected time interval between the trigger pulses.

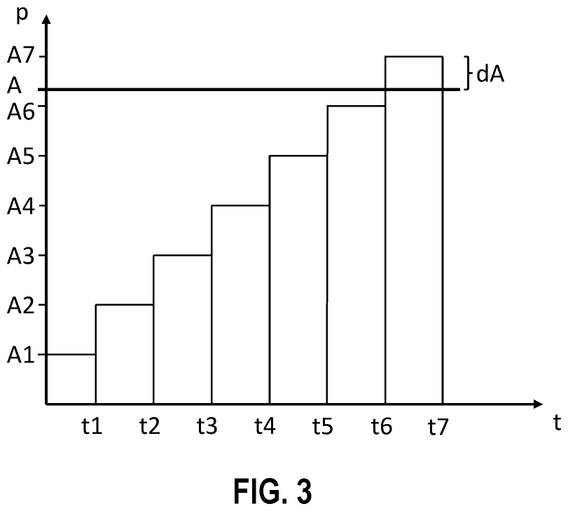

The integration of the target speed along the path is illustrated in FIG. 3. The time since the last trigger point in time is shown on the horizontal axis. The vertical axis shows the position along the path or the distance to the preceding laser spot along the path.

Depending on the application, a certain desired (length-wise) distance along the path between two successive laser spots which are to be generated would be specified. This distance is marked with A. The target speed along the path is now integrated (in particular numerically) over a first time interval t1 in order to determine a first distance A1 therefrom. This distance A1 is compared with the desired distance A. If the distance A1 has not yet reached the desired distance A, the method is continued or repeated, i.e. the integration of the target speed along the path is continued in a second time interval t2 and the result is again compared with the desired distance A. The time integration intervals t1 to to can all have the same or a different length. The integration is continued until the distance along the path determined by the integration has reached or exceeded the desired distance A. In FIG. 3, this is the case after the integration interval t7.

In many cases the distance along the path determined by the integration will not exactly reach the desired distance A, but—depending on the choice of the integration interval—will exceed it slightly. As soon as the distance along the path determined by the integration has reached or exceeded the desired distance A (A7), the point in time for the triggering of the laser 2, or the time interval between a first triggering of the laser 2 and a subsequent, second triggering of the laser 2, can be determined by summing up the time intervals t1 to t7 used in the course of the integration. The two laser spots generated by the first and the second triggering will then have the desired distance A or a distance A′ (A7 in FIG. 3) that will (slightly) exceed the desired distance A by a distance difference dA.

When the method is continued in order to determine the trigger point in time for a third laser spot, the distance difference dA can be taken into account. Thus, the integration or the summation can start with an initial value which is different from zero, whereby this initial value corresponds to the distance difference dA. As a result, the desired distance A is reached faster than would be the case purely on the basis of an integration of the target speed along the path over the integration time intervals. This in turn means that the time interval until the third trigger point in time of the laser 2 and thus also the (length-wise) distance along the path between the second and the third laser spots is reduced slightly. In particular, the length-wise distance between the second and the third laser spots may then possibly be (slightly) smaller than the desired distance A. It is to be expected that the deviations of the distances from the desired distance A will balance each other out on average, so that the average distance approximately corresponds to the desired distance.

The method can be continued in a corresponding manner for further trigger points in time or laser spots.

This example embodiment also provides for the case that the method can be adapted accordingly if the desired distances along the path between two successive laser spots are not constant.

### Example Embodiment 2: Actual Speed

The method according to the second example embodiment is very similar to that of the first one. The main difference is that the integration is not based on the target speed, but on the actual speed V_{Ist}. The actual speed along the path can be determined by measurement of the current axis positions of the deflection mirrors 4.

### Variant: Higher Time Derivatives

As a variant to the example embodiments 1 and 2, instead of the target speed or the actual speed along the path, higher time derivatives of the target position or the actual position along the path can also be used for the integration. In such a case the integration would accordingly have to be carried out several times, so that the result of the integration corresponds to the distance along the path.

### Example Embodiment 3: Target Position

The third example embodiment is similar to the first in that, again, target values which result from the controlling of the deflection elements 4 are used, as opposed to (measured) actual values. However, in the third example embodiment, the target position is used instead of the target speed. In this case there is no need to carry out any integration. Instead, after a sufficiently small time interval, which preferably is again significantly smaller than the temporal pulse interval to be expected, a check takes place as to whether the target position along the path corresponds to a distance (with respect to a preceding laser spot) along the path that corresponds to the desired distance of the laser spots or has exceeded the desired distance along the path. As soon as this is the case, the trigger point in time to be used can be determined from this. Otherwise, a time interval is added and the comparison is carried out again.

As in the first and second example embodiment, in the course of the third example embodiment it can also be taken into account to what extent the desired distance between two laser spots has been exceeded, i.e. a distance difference dA can again be determined. This in turn means that, when the subsequent trigger point in time is being determined, the desired distance A will be reached faster than would be the case purely on the basis of the target positions along the path. As a result, on average, the actual distance between successive laser spots can again converge towards the desired distances between these laser spots.

### Variants

In a first variant to the example embodiments described above, it would be possible to determine successive trigger points in time without taking into account to what extent a preceding laser spot has exceeded the desired distance. This can simplify the computational complexity, because no “carry” from the calculation of a preceding trigger point in time has to be taken into account as part of the determination of a subsequent trigger point in time. On each occasion the calculation starts at “zero”, so to speak. However, it is to be expected that the distances determined between the laser spots will be (slightly) larger than the desired distances between these.

According to a second variant to the first and second example embodiments, the target or actual velocity values used for the integration are interpolated, in particular using a linear interpolation. In this context, a time interval between two such interpolation points in time can be significantly longer than the duration of one of the integration intervals. The points of time between which the interpolation takes place can be given by a clock frequency of a control card of the laser beam positioning system. In one embodiment, this clock frequency can for example be a few microseconds, for example 10 μs, while an integration interval can for example be a few nanoseconds, for example 5 to 20 ns. For each integration time interval, a velocity value can thus be approximated in a relatively simple way. The inventors have appreciated that such an interpolation usually requires considerably less computing capacity than, for example, an analytical determination of the velocity for each integration interval. At least with a suitable choice of the points in time between which the interpolation takes place, this interpolation method provides results with completely sufficient accuracy for most applications.

### Further Explanations/Example Embodiments

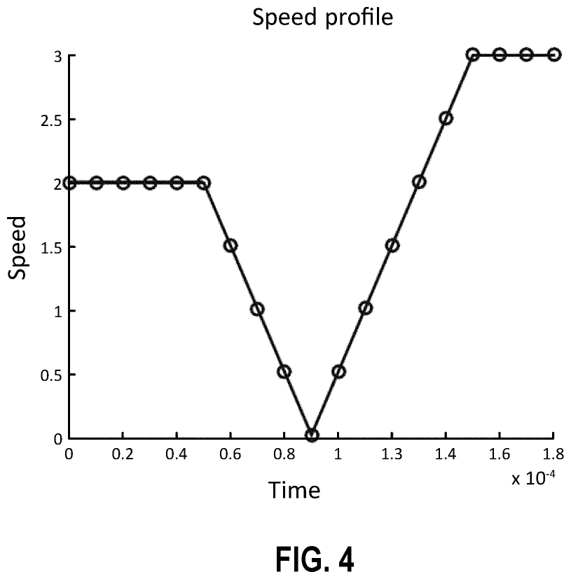

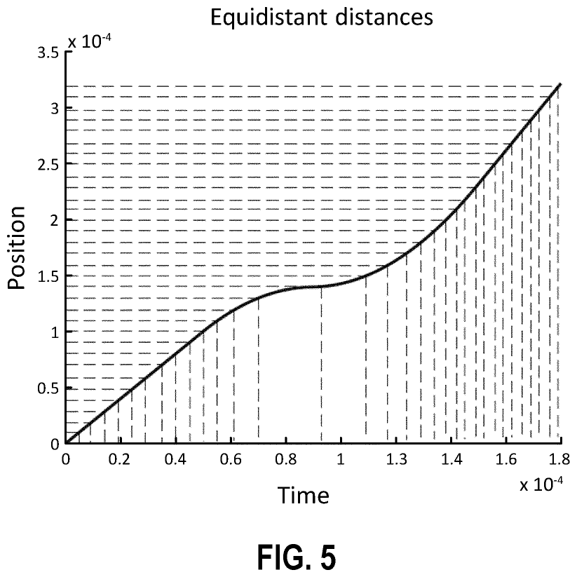

In many applications, it will be desirable to generate hundreds of laser spots, possibly thousands of laser spots or far more. It may be desired that the distances between successive laser spots have a desired distribution, for example that the distances are substantially constant. It has already been mentioned that a laser which is triggered with a constant clock frequency generally will not (or not necessarily) generate equidistant laser spots. This is because the speed of the optical path along the path needs to be taken into account. This is explained with reference to FIGS. 4 and 5.

FIG. 4 shows, by way of example, a velocity profile (arbitrary units) of an optical path along a path (spot velocity). First, the spot velocity is constant (until time 0.5) and is then reduced to zero (time 0.9). After that, the spot velocity increases again. After it has reached a maximum value (time 1.5), it remains constant. Such a velocity profile could be used, for example, if the desired path has a tight curve or a corner. Due to dynamic limits (max. speed, max. acceleration, max. jerk) such a slowing down and re-accelerating may be necessary.

Example embodiments of the invention take into account the profile of the spot velocity when determining the trigger points in time, as shown in FIG. 5. In the example (velocity profile as in FIG. 4, equidistant distances along the path are desired), the time interval between two trigger points in time is adapted to the changing spot velocity. While in the initial phase (constant speed until time 0.5) the time interval between two trigger points in time remains the same, the time intervals become longer after this (longest around time 0.9). Thereafter, they become shorter again and remain the same from time 1.5 onwards. In spite of the changing spot velocity, laser spots with equidistant distances along the path are obtained by triggering the laser at the points in time which have been determined in accordance with embodiments of the invention.

In further example embodiments, however, it may also be desired that the energy input per length of the path corresponds to a desired distribution, for example, that it remains constant. The energy input per length of the path can be varied according to example embodiments of the present invention by suitable selection of the distance between successive laser spots or by suitable selection of the energy per laser spot (pulse energy). It is also possible to vary both the distance between successive laser spots and the energy per laser spot in order to influence the energy input per length of the path.

When choosing the distance between successive laser spots and/or the energy per laser spot, the fact may possibly also be taken into account that the shape of the laser spots varies in dependence upon the position in the processing area.

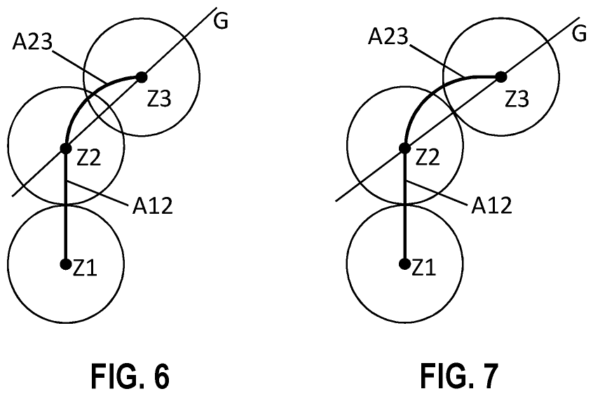

FIG. 6 shows three successive laser spots. These are representative for a series of more than three laser spots. The centers of the laser spots are marked by the reference signs Z1, Z2 and Z3. Each of the three laser spots has a certain extent, which is illustrated by circles.

The distance between the first and second laser spots along the path 7 is marked A12, and the distance along the path between the second and third laser spots is marked A23. The path 7 is curved, whereby the curvature in FIG. 6 is greatly exaggerated. With a constant distance along the path, i.e. A12=A23, the centers Z2 and Z3 are closer together along a straight line G (i.e. not along the path) than the centers Z1 and Z2. While the first and second laser spots do not overlap, the second and third laser spots partially overlap due to the curvature of the path. This is not desirable in some applications. According to an example embodiment of the present invention, this can be taken into account when determining the successive trigger points in time of the laser 2, i.e. the desired distance A (FIG. 3) can be selected to be larger for the second and third laser spots, i.e. on curves, than between the first and second laser spots, i.e. on substantially straight sections of the path. This is shown in FIG. 7, where the distance A23 along the path is larger than the distance A12 along the path. In particular, the distance A23 could be selected so that the laser spots have a desired distance to each other at the outer or the inner contour of the curved path.

Alternatively, under certain circumstances it would be possible to adjust the extent of the laser spots accordingly, i.e. smaller on curves than on substantially straight sections, or the energy per laser spot (pulse energy) could be adjusted accordingly so that, despite the overlapping of the laser spots, the energy input per length of the path corresponds to the desired distribution, for example that it remains constant.

The inventors envisage the following as a specific implementation of an example embodiment. Based on the target path and the dynamic limits (max. speed, max. acceleration, max. jerk) of the system to be used, a navigable trajectory is pre-calculated in discrete steps (for example 10 μs) for all axes. The output for the axes can be shifted in time, in order to compensate for propagation time differences etc. Position controllers which are free of tracking errors are used for all axes, so that the deviation between the target path and the actual path can be neglected. The focus velocity (or spot velocity or speed of the optical path along the path) is calculated according to the same clock (in this example in 10 μs cycles). The laser power and the spot distance (distance between the laser spots) can be changed in 10 μs cycles if necessary. The laser power can be pre-calculated in dependence upon the speed, the laser frequency, the position, the angle of incidence and the path curvature etc. Alternatively, these values can also be included as a correction term in a “pseudo speed”. A minimum laser frequency can also be taken into account in the “pseudo speed”.

In order to generate the laser trigger signal, the velocity signal is linearly interpolated and integrated within the 10 μs interval, whereby the summing up is carried out e.g. according to a clock of a few ns. When the desired spot distance is exceeded, a defined pulse is triggered and the counter reading is reduced by the spot distance.

### Summarized Description of a Method Flow According to the Invention

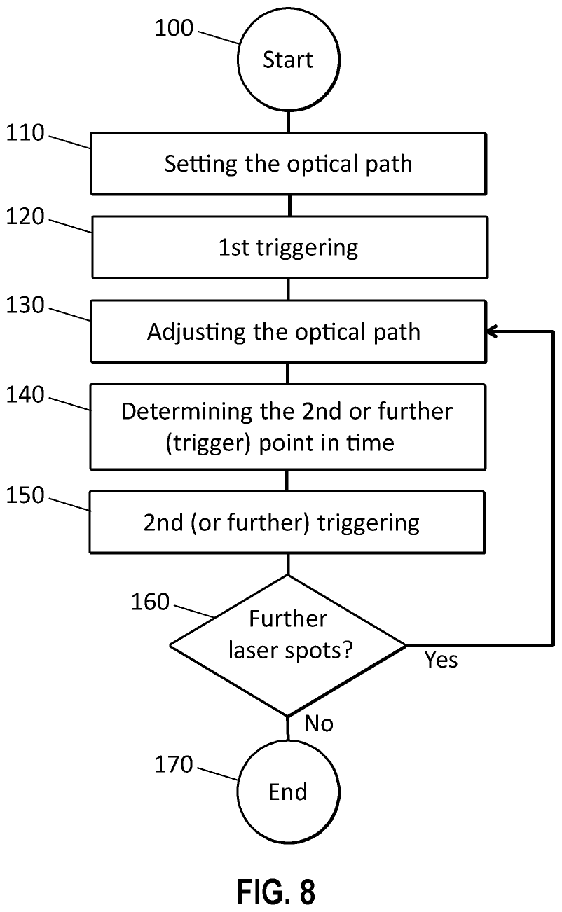

FIG. 8 shows, in a summarized manner, a method flow according to example embodiments of the invention. After the start 100 of the method flow, the optical path described above is set (step 110). It is also possible for the desired initial state of the optical path to be present at the beginning of the process.

In a next step 120, the laser 2 is triggered at a first point in time in order to generate a first laser spot on the path 7.

The optical path is adjusted in a next step 130. It should be noted here that the initial setting (110) and the subsequent adjustment (130) can, in many embodiments, be regarded as a continuous process.

In a further step 140, a second point in time is determined at which the laser 2 is to be triggered for a second time.

In a next step 150, the laser 2 is triggered at the second point in time previously determined, in order to generate a second laser spot on the path 7.

In a further step 160 a check is made as to whether any further laser spots should be generated. If Yes, the method flow is repeated from step 130. If No, the method flow is terminated (step 170).

Although in FIG. 8, the step 140 is shown after the step 130, it should be noted that, potentially, the step 140 could already take place before the step 130, possibly even before the steps 120 or 110, at least if target values such as for example the target speed are used to determine the second trigger point in time (and further trigger points in time).

### Possible Fields of Application

The present invention can be used for laser-based material processing. This may comprise, for example, one or more of the following processes: marking, inscribing, material processing involving ablation and/or structuring, cutting, drilling, additive manufacturing and welding.

The present invention can be used if the laser has a clock frequency of 100 kHz or more, in particular several 100 kHz or in the MHz range.

Typical velocities of the laser beam on an object/workpiece are for example approx. 0.5 to approx. 10 m/s, but can also be (significantly) higher.

It should further be noted that the exemplary embodiments are merely examples which are not intended to limit the scope of protection, the possible applications and the configuration in any way. Rather, the preceding description will provide the person skilled in the art with a guideline for the implementation of at least one exemplary embodiment, whereby various changes, in particular with respect to the function and arrangement of the components described, can be made without deviating from the scope of protection as it results from the claims and combinations of features equivalent thereto.

What is claimed is:

1. A method of controlling a laser processing device having at least one laser, comprising:
setting an optical path of the laser processing device by at least one deflection element, including at least one rotatable mirror, so that a path point which can be generated by a laser beam following the optical path lies on a desired path on or in an object;
a first triggering of the laser at a first point in time so as to generate a first laser spot;
adjusting, in particular continuously adjusting, the optical path of the laser processing device by the at least one rotatable mirror, so that a path point which can be generated by the laser beam following the optical path lies on the desired path;
a second triggering of the laser at a second point in time so as to generate a second laser spot;
wherein the method comprises the following step before the second triggering:
determining the second point in time on the basis of at least one of a target position, a first or a higher time derivative thereof, and a first or a higher time derivative of an actual position of the path point of the optical path along the desired path, so that a position of the second laser spot has a desired distance, along the desired path, to a position of the first laser spot.

2. The method according to claim 1, wherein the second point in time is a point in time at which the path point of the optical path has reached or exceeded a desired minimum distance along the desired path from the position of the first laser spot.

3. The method according to claim 1, further comprising:
(a) at least a third triggering of the laser; and
(b) ensuring that, per length of the desired path, an energy which is transmitted onto the object by the laser beam substantially corresponds to a desired distribution.

4. The method according to claim 3, wherein the desired distribution specifies that an energy per length of the desired path is substantially constant.

5. The method according to claim 3, wherein the desired distribution specifies that an energy per length of the desired path is lower in curves of the desired path than on substantially straight sections of the desired path.

6. The method according to claim 3, wherein a distance between successive laser spots is varied so that an energy per length of the desired path substantially corresponds to the desired distribution.

7. The method according to claim 3, wherein an energy which is transmitted onto the object by the laser beam in order to generate a laser spot is varied for different laser spots so that an energy per length of the desired path substantially corresponds to the desired distribution.

8. The method according to claim 3, wherein the laser spots have a size, and the desired distribution specifies that successive laser spots do not overlap.

9. The method according to claim 2, wherein the second point in time is determined on the basis of the first or the higher time derivative of the target position or the actual position as follows:
repeating of the following steps:
(a) integrating the first or the higher time derivative of the target position or the actual position over a time interval in order to determine a first distance along the desired path; and
(b) comparing the first distance with the desired minimum distance along the desired path, until the first distance corresponds to, or exceeds, a desired minimum distance along the desired path; and
determining the second point in time from a sum of the time intervals.

10. The method according to claim 9, wherein further points in time which are subsequent to the second point in time are determined according to the determination of the second point in time, however while additionally taking into account to what extent the desired minimum distance was exceeded during a course of the determination of the preceding point in time.

11. The method according to claim 9, wherein further points in time which are subsequent to the second point in time are determined according to the determination of the second point in time, without taking into account to what extent the desired minimum distance was exceeded during the course of the determination of the preceding point in time.

12. The method according to claim 2, wherein the second point in time is determined on the basis of the target position as follows:
for a given point in time, determining whether the target position which is associated with the given point in time corresponds to a distance along the desired path that is equal to the desired minimum distance or has exceeded the desired minimum distance along the desired path;
if yes, using the given point in time as the second point in time;
if no, adding a time interval to the given point in time; and
repeating the preceding steps.

13. A computer program product comprising a program code which is stored on a computer-readable medium for carrying out a method comprising:
setting an optical path of the laser processing device by at least one deflection element, including at least one rotatable mirror, so that a path point which can be generated by a laser beam following the optical path lies on a desired path on or in an object;
a first triggering of the laser at a first point in time so as to generate a first laser spot;
adjusting, in particular continuously adjusting, the optical path of the laser processing device by the at least one rotatable mirror, so that a path point which can be generated by the laser beam following the optical path lies on the desired path;
a second triggering of the laser at a second point in time so as to generate a second laser spot;
wherein the method comprises the following step before the second triggering:
determining the second point in time on the basis of at least one of a target position, a first or a higher time derivative thereof, and a first or a higher time derivative of an actual position of the path point of the optical path along the desired path, so that a position of the second laser spot has a desired distance, along the desired path, to a position of the first laser spot.

14. (canceled)

15. A laser beam positioning system for controlling a laser processing device, the laser beam positioning system comprising:
at least one deflection element, including at least one rotatable mirror,
means for setting or continuously adjusting, the at least one rotatable mirror, in order to set or adjust an optical path of the laser beam positioning system in such a way that a path point which can be generated by a laser beam following the optical path lies on a desired path on or in an object;
means for triggering, at first and second points in time, a laser to be used with the laser beam positioning system in order to generate a first and a second laser spot; and
means for determining the second point in time on the basis of at least one of a target position, a first or a higher time derivative thereof, and a first or a higher time derivative of an actual position of the path point of the optical path along the desired path, so that a position of the second laser spot has a desired distance, along the desired path, to a position of the first laser spot.

16. A laser processing device comprising:
the laser beam positioning system according to claim 15; and
a laser.

17. The laser beam positioning system of claim 15, wherein the laser beam positioning system performs a method comprising:
setting an optical path of the laser processing device by at least one deflection element, including at least one rotatable mirror, so that a path point which can be generated by a laser beam following the optical path lies on a desired path on or in an object;
a first triggering of the laser at a first point in time so as to generate a first laser spot;
adjusting, in particular continuously adjusting, the optical path of the laser processing device by the at least one rotatable mirror, so that a path point which can be generated by the laser beam following the optical path lies on the desired path;
a second triggering of the laser at a second point in time so as to generate a second laser spot;
wherein the method comprises the following step before the second triggering:
determining the second point in time on the basis of at least one of a target position, a first or a higher time derivative thereof, and a first or a higher time derivative of an actual position of the path point of the optical path along the desired path, so that a position of the second laser spot has a desired distance, along the desired path, to a position of the first laser spot.

18. The method according to claim 3, wherein the laser spots have a size, and the desired distribution specifies that successive laser spots overlap only up to a maximum specified extent.
